(19) United States
(12) Patent Application Publication
(10) Pub. No.: US 2016/0285109 A1
(43) Pub. Date: Sep. 29, 2016

(54) CATHODE CATALYST FOR AIR SECONDARY BATTERIES, CATHODE CATALYST LAYER FOR AIR SECONDARY BATTERIES AND AIR SECONDARY BATTERY

(71) Applicant: SUMITOMO CHEMICAL COMPANY, LIMITED, Chuo-ku, Tokyo (JP)

(72) Inventors: Nobuyoshi KOSHINO, Tsukuba-shi (JP); Akihiro YUASA, Tsukuba-shi (JP)

(73) Assignee: SUMITOMO CHEMICAL COMPANY, LIMITED, Tokyo (JP)

(21) Appl. No.: 15/034,558

(22) PCT Filed: Nov. 12, 2014
(86) PCT No.: PCT/JP2014/080565

§ 371 Date: May 5, 2016

(30) Foreign Application Priority Data
Nov. 18, 2013 (JP) 2013-237639

(51) Int. Cl. H01M 4/90; H01M 4/86; H01M 12/08; C01G 51/04

(52) U.S. Cl. CPC H01M 4/9016; C01G 51/04; H01M 4/9008; H01M 4/8673; H01M 4/8668; H01M 12/08; H01M 2004/8689

(57) ABSTRACT

(i) A cathode catalyst for air secondary batteries comprising an oxyhydroxide of a metal, (ii) A cathode catalyst for air secondary batteries comprising the oxyhydroxide of a metal and a metal complex, (iii) A cathode catalyst layer for air secondary batteries comprising the catalyst and (iv) An air secondary battery comprising them.

### TECHNICAL FIELD

The present invention relates to a cathode catalyst for air secondary batteries, a cathode catalyst layer for air secondary batteries and an air secondary battery.

### BACKGROUND ART

An air battery needs no accommodation of a cathode active material in the battery because oxygen as a cathode active material is fed from the outside of the battery, thus, a large amount of an anode active material can be filled in the battery. Therefore, air batteries can attain very high energy density.

Of air batteries, air secondary batteries which can store electricity by performing charging and can be used repeatedly (namely, which can be charged and discharged repeatedly using oxygen in air as an active material) have attracted attention, and development thereof has been advanced, recently.

As the cathode catalyst used in an air secondary battery, for example, perovskite: LaCoO₃ doped with calcium is known (Non-patent document 1).

### PRIOR ART DOCUMENT

### Non-Patent Document

Non-patent document 1: Nae-Lih Wu et al, “Effect of oxygenation on electrocatalysis of La_{0.6}Ca_{0.4}CoO₃₋ₓ in bifunctional air electrode”, Electrochimica Acta 2003, 48, 1567-1571

### SUMMARY OF THE INVENTION

### Problem to be Solved by the Invention

The above-described cathode catalyst using perovskite: LaCoO₃ doped with calcium, however, has a problem of insufficient charge activity.

The present invention has been accomplished in view of such circumstances, and provides a cathode catalyst for air secondary batteries showing excellent charge activity, a cathode catalyst layer for air secondary batteries showing excellent charge activity and an air secondary battery showing excellent charge activity.

That is, the present invention provides the following inventions [1] to [11].

[1] A cathode catalyst for air secondary batteries comprising an oxyhydroxide of a metal.

[2] The cathode catalyst for air secondary batteries according to [1], wherein the metal is at least one metal selected from the group consisting of iron, cobalt, manganese and nickel.

[3] The cathode catalyst for air secondary batteries according to [1] or [2], wherein the oxyhydroxide of a metal is cobalt oxyhydroxide.

[4] The cathode catalyst for air secondary batteries according to any one of [1] to [3], further comprising a metal complex.

[5] The cathode catalyst for air secondary batteries according to [4], wherein a metal atom or a metal ion contained in the metal complex is manganese, manganese ion, iron, iron ion, cobalt, cobalt ion, copper, copper ion, zinc or zinc ion.

[6] The cathode catalyst for air secondary batteries according to [4] or [5], wherein the metal complex is a polynuclear metal complex.

[7] The cathode catalyst for air secondary batteries according to any one of [4] to [6], wherein a ligand contained in the metal complex is an aromatic compound.

[8] The cathode catalyst for air secondary batteries according to any one of [4] to [7], wherein the content of the metal complex is 0.1 to 1 part by mass per part by mass of the oxyhydroxide of a metal.

[9] A cathode catalyst layer for air secondary batteries comprising the cathode catalyst for air secondary batteries according to any one of [1] to [8].

[10] The cathode catalyst layer for air secondary batteries according to [9], comprising 1 to 20 parts by mass of a conductive material and 0.5 to 5 parts by mass of a binder per part by mass of the cathode catalyst for air secondary batteries.

[11] An air secondary battery comprising the cathode catalyst for air secondary batteries according to any one of [1] to [8] or the cathode catalyst layer for air secondary batteries according to [9] or [10].

### Effect of the Invention

The present invention can provide a cathode catalyst for air secondary batteries showing excellent charge activity, a cathode catalyst layer for air secondary batteries showing excellent charge activity and an air secondary battery showing excellent charge activity.

Further, according to preferable embodiments, the present invention can provide a cathode catalyst for air secondary batteries which is synthesized easily and needs low production cost and an air secondary battery which can be charged in a short period of time.

According to other preferable embodiments, the present invention can provide a cathode catalyst for air secondary batteries showing excellent charge and discharge activity and excellent cycling efficiency, a cathode catalyst layer for air secondary batteries showing excellent charge and discharge activity and excellent cycling efficiency and an air secondary battery showing excellent charge and discharge activity and excellent cycling efficiency.

### BRIEF EXPLANATION OF DRAWING

FIG. 1 is a diagrammatic schematic view showing one example of the air secondary batteries according to the present embodiments.

### MODES FOR CARRYING OUT THE INVENTION

The present embodiments will be illustrated in detail below.

### <Cathode Catalyst for Air Secondary Batteries>

The cathode catalyst for air secondary batteries of the present invention (hereinafter, also referred to simply as “cathode catalyst”) comprises an oxyhydroxide of a metal.

### (Oxyhydroxide of Metal)

The oxyhydroxide of a metal is a compound in which one metal has both at least one oxo group and at least one hydroxyl group. The oxyhydroxide of a metal may be hydrated with one or more water molecules.

The metal of the oxyhydroxide of a metal is, for example, a transition metal, and preferable are one or more metals selected from the group consisting of iron, cobalt, manganese and nickel, more preferable are iron and cobalt, further preferable is cobalt.

The oxyhydroxide of a metal includes, for example, iron oxyhydroxide, cobalt oxyhydroxide, manganese oxyhydroxide and nickel oxyhydroxide, preferably iron oxyhydroxide and cobalt oxyhydroxide, more preferably cobalt oxyhydroxide.

The oxyhydroxides of a metal may each be used singly or two or more of them may be used in admixture. When two or more oxyhydroxides are used in admixture, they may be mixed by any know methods and, for example, may be mixed by using an agate mortar.

### (Method of Producing Oxyhydroxide of Metal)

Next, the method of synthesizing the oxyhydroxide of a metal preferably used in the present invention will be illustrated. The oxyhydroxide of a metal may be produced by any known methods and, for example, can be produced by the following method.

The oxyhydroxide of a metal can be produced, for example, by adding an alkaline solution to an aqueous solution of a metal salt, stirring them and separating the mixture by filtration.

The metal salt includes, for example, an acetate, a fluoride, a chloride, a bromide, an iodide, a sulfate, a carbonate, a nitrate, a hydroxide, a phosphate, a perchlorate, a trifluoroacetate, trifluoromethanesulfonic acid, a tetrafluoroborate, a hexafluorophosphate and a tetraphenylborate, preferably an acetate, a chloride and a hydroxide.

The acetate includes, for example, cobalt(II) acetate, cobalt(III) acetate, iron(II) acetate, iron(III) acetate, manganese(II) acetate, manganese(III) acetate and nickel(II) acetate.

The chloride includes, for example, cobalt(II) chloride, iron(II) chloride, iron(III) chloride, manganese(II) chloride and nickel(II) chloride.

The hydroxide includes, for example, cobalt(II) hydroxide, iron(II) hydroxide, manganese(II) hydroxide and nickel(II) hydroxide.

Of them, cobalt(II) acetate, cobalt(II) chloride and cobalt(II) hydroxide are particularly preferable as the metal salt.

The metal salt may be hydrate. The hydrate includes, for example, cobalt(II) acetate tetrahydrate, manganese(II) acetate tetrahydrate, manganese(III) acetate dihydrate, nickel(II) acetate tetrahydrate and iron(III) acetate nonahydrate.

The aqueous solutions of these metal salts may each be used singly or two or more of them may be used in combination.

The alkaline solution to be added to the aqueous solution of the metal salt includes, for example, aqueous solutions of lithium hydroxide, sodium hydroxide, potassium hydroxide, barium hydroxide, magnesium hydroxide, calcium hydroxide and the like, preferably aqueous solutions of sodium hydroxide, potassium hydroxide and calcium hydroxide, more preferably aqueous solutions of sodium hydroxide and calcium hydroxide. These alkaline solutions may each be used singly or two or more of them may be used in combination.

The temperature for mixing the aqueous solution of the metal salt and the alkaline solution is preferably 0° C. or more and 90° C. or less, more preferably 5° C. or more and 70° C. or less, further preferably 10° C. or more and 50° C. or less.

The time for mixing the aqueous solution of the metal salt and the alkaline solution is preferably one minute or more and one week or less, more preferably 5 minutes or more and 24 hours or less, further preferably 10 minutes or more and 12 hours or less.

For identification of the resultant oxyhydroxide of a metal, powder X-ray diffraction, elemental analysis, infrared spectrometry and the like can be used.

### (Metal Complex)

The cathode catalyst for air secondary batteries can contain another metal complex, in addition to the metal complex described above, for improving charge and discharge activity.

The another metal complex has a metal atom or metal ion, and a ligand.

The metal atom or metal ion is preferably manganese, a manganese ion, iron, an iron ion, cobalt, a cobalt ion, copper, a copper ion, zinc or a zinc ion, more preferably cobalt or a cobalt ion, further preferably a cobalt ion. The same shall apply to M described later.

The ligand is preferably an aromatic compound.

When the another metal complex has positive charge, the complex may contain a counter ion for electrically neutralizing this. The counter ion includes, for example, an acetate ion, a fluoride ion, a chloride ion, a bromide ion, an iodide ion, a sulfate ion, a carbonate ion, a nitrate ion, a hydroxide ion, a perchlorate ion, a trifluoroacetate ion, a trifluoromethanesulfonate ion, a tetrafluoroborate ion, a hexafluorophosphate ion and a tetraphenylborate ion. When there exist a plurality of counter ions, they may be the same or different. The same shall apply to mononuclear metal complexes and polynuclear metal complexes described later.

The another metal complex includes, for example, mononuclear metal complexes such as metal phorphyrins and metal phthalocyanines; polynuclear metal complexes having a plurality of metal atoms or metal ions in one molecule; and metal cluster complexes, preferably mononuclear metal complexes and polynuclear metal complexes, more preferably polynuclear metal complexes.

Specific structural formulae of the mononuclear metal complex will be exemplified. M represents a metal atom or metal ion. A hydrogen atom which the metal complex represented by these structural formulae has may be substituted with an alkyl group, an alkoxy group, an aryl group or the like.

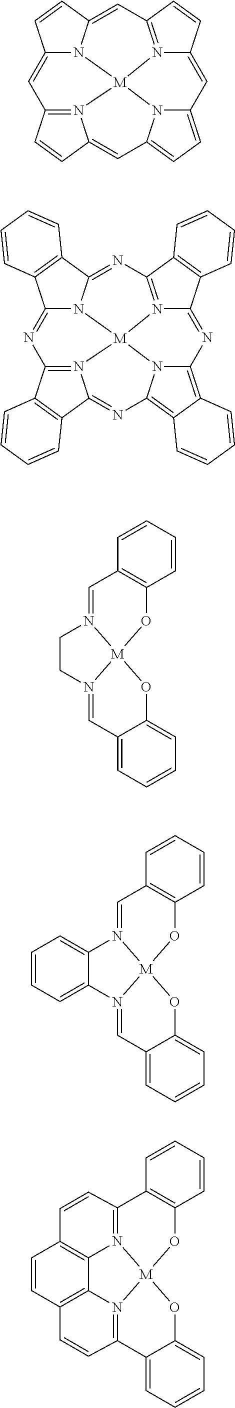

Specific structural formulae of the polynuclear metal complex will be exemplified. M represents a metal atom or metal ion. A plurality of M may be the same or different. A hydrogen atom which the metal complex represented by these structural formulae has may be substituted with an alkyl group, an alkoxy group, an aryl group or the like.

The charge of the polynuclear metal complex is omitted.

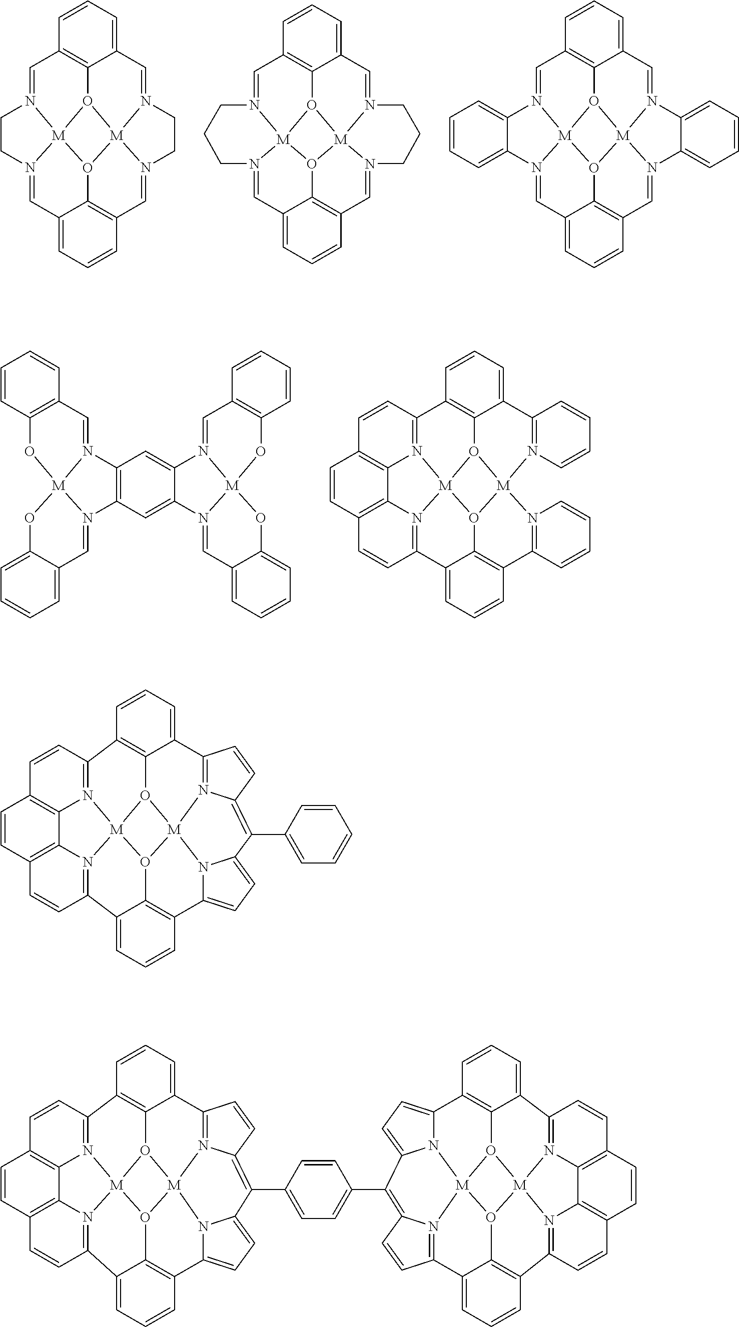

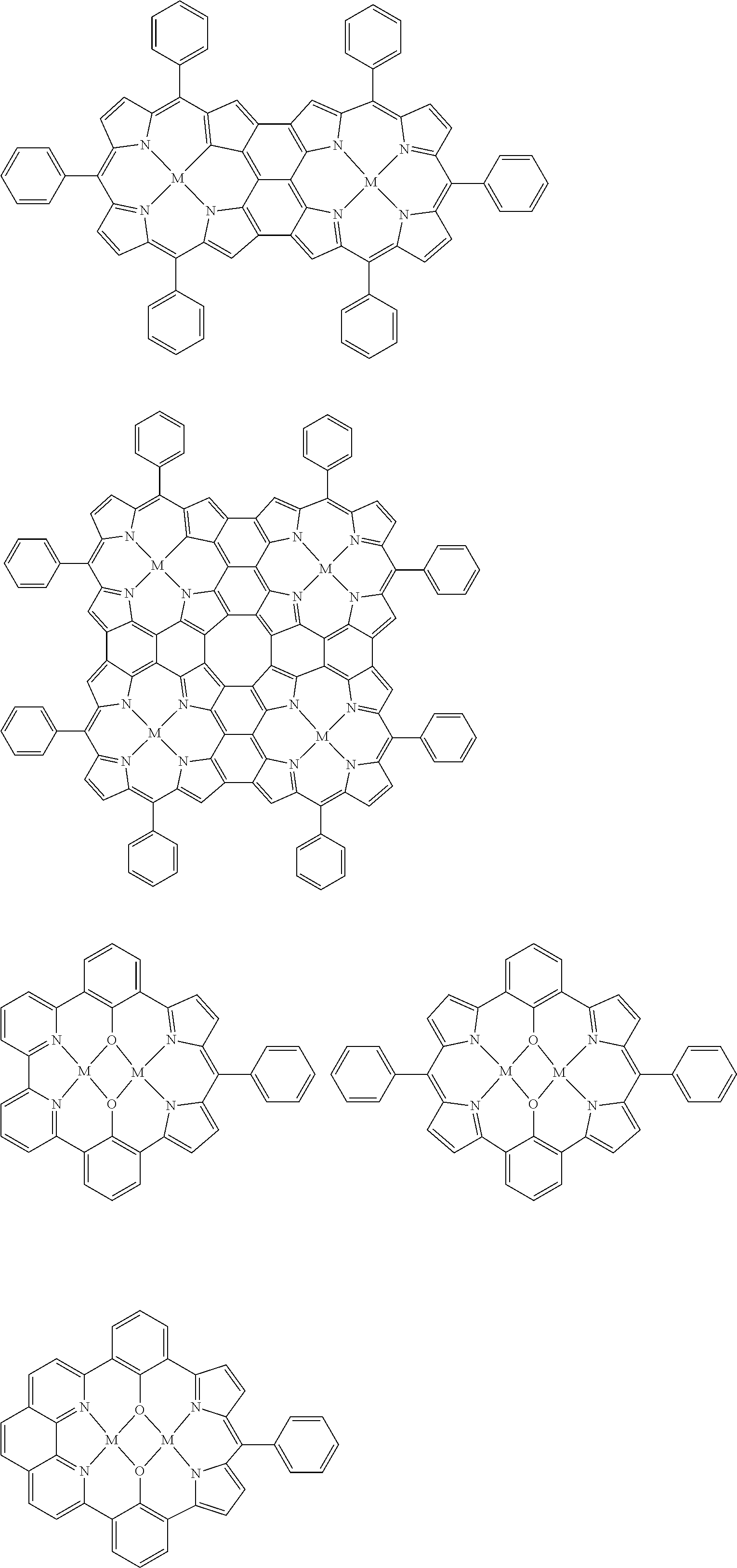

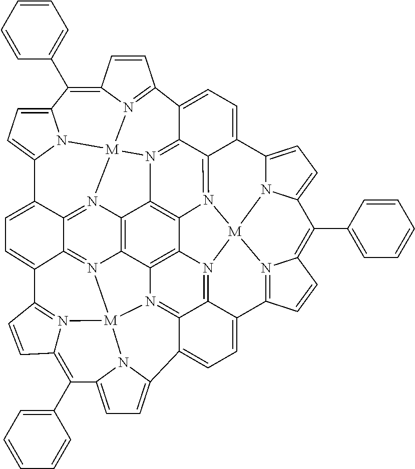

The content of the another metal complex is usually 0.1 to 1 part by mass, preferably 0.2 to 0.8 parts by mass, more preferably 0.3 to 0.6 parts by mass per part by mass of the oxyhydroxide of a metal.

### (Method of Producing Metal Complex)

Next, the method of synthesizing the metal complex preferably used in the present invention will be illustrated.

The metal complex used in the present invention is produced, for example, by organochemically synthesizing a compound acting as a ligand (hereinafter, referred to as “ligand compound”), then, mixing this with a reacting agent imparting a metal atom or metal ion (hereinafter, referred to as “metal imparting agent”), and reacting them. The amount of the metal imparting agent is not particularly restricted and may be adjusted according to the intended metal complex, and in usual cases, excess amount for the ligand compound is preferable.

The metal imparting agent includes an acetate, a fluoride, a chloride, a bromide, an iodide, a sulfate, a carbonate, a nitrate, a hydroxide, a perchlorate, a trifluoroacetate, a trifluoromethanesulfonate, a tetrafluoroborate, a hexafluorophosphate, a tetraphenylborate and the like, preferably an acetate. The acetate includes, for example, cobalt(II) acetate, cobalt(III) acetate, iron(II) acetate, iron(III) acetate, manganese(II) acetate, manganese(III) acetate, nickel(II) acetate, copper(II) acetate and zinc(II) acetate, preferably cobalt acetate.

The metal imparting agent may also be a hydrate. The hydrate includes, for example, cobalt(II) acetate tetrahydrate, manganese(II) acetate tetrahydrate, manganese(III) acetate dihydrate, nickel(II) acetate tetrahydrate, copper(II) acetate monohydrate and zinc(II) acetate dihydrate.

The process of mixing the ligand compound and metal imparting agent is conducted usually in the presence of a suitable solvent. The solvent used in the reaction (reaction solvent) includes water; organic acids such as acetic acid and propionic acid; amines such as ammonia water and triethylamine; alcohols such as methanol, ethanol, n-propanol, isopropyl alcohol, 2-methoxyethanol, 1-butanol and 1,1-dimethylethanol; aromatic hydrocarbons such as ethylene glycol, diethyl ether, 1,2-dimethoxyethane, methyl ethyl ether, 1,4-dioxane, tetrahydrofuran (hereinafter, referred to as “THF”), benzene, toluene, xylene, mesitylene, durene and decalin; halogen-based solvents such as dichloromethane, chloroform, carbon tetrachloride, chlorobenzene and 1,2-dichlorobenzene; N,N′-dimethylformamide, N,N′-dimethylacetamide, N-methyl-2-pyrrolidone, dimethyl sulfoxide, acetone, acetonitrile, benzonitrile, triethylamine, pyridine and the like. The solvents may each be used singly or two or more of them may be used in combination. As the solvent, solvents in which the compound acting as a ligand and the metal imparting agent can be dissolved are preferable. Here, the ligand compound is preferably an aromatic compound.

The temperature for mixing the ligand compound and metal imparting agent is preferably −10° C. or more and 250° C. or less, more preferably 0° C. or more and 200° C. or less, further preferably 0° C. or more and 150° C. or less.

The time for mixing the ligand compound and metal imparting agent is preferably 1 minute or more and 1 week or less, more preferably 5 minutes or more and 24 hours or less, further preferably 1 hour or more and 12 hours or less. It is preferable that the mixing temperature and the mixing time are adjusted in view of the kinds of the ligand compound and the metal imparting agent.

The metal complex generated can be taken out from the solvent by selecting a suitable method from known recrystallization methods, reprecipitation methods and chromatography methods and applying the suitable method, and in this case, some of the methods may be combined. Depending on the kind of the solvent, the generated polynuclear metal complex may deposit, and in this case, it is advantageous that the metal complex deposited is separated by filtration and the like, then, subjected to washing, drying and the like.

The metal complexes may each be used singly or two or more of them may be used in admixture.

The oxyhydroxide of a metal and the metal complex may be mixed by any known methods and, for example, may be mixed by using an agate mortar.

In the cathode catalyst, the oxyhydroxide of a metal is contained in a content of preferably 1 to 99% by mass (% by weight), more preferably 5 to 95% by mass (% by weight), further preferably 10 to 90% by mass (% by weight).

### (Other Substances)

The cathode catalyst for air secondary batteries can contain inorganic oxides such as perovskite type oxides, spinel type oxides and olivine type oxides; noble metals such as platinum and silver, in addition to the metal complexes described above.

### (Cathode Catalyst Layer for Air Secondary Batteries)

The cathode catalyst layer for air secondary batteries of the present invention (hereinafter, also referred to simply as “cathode catalyst layer”) contains the cathode catalyst for air secondary batteries of the present invention. As the cathode catalyst layer, those comprising a conductive material and a binder in addition to the cathode catalyst are preferable.

The conductive material may be one which can improve the electric conductivity of the cathode catalyst layer, and carbon is preferable.

Exemplified as the carbon are carbon blacks such as “Norit” (manufactured by NORIT), “Ketjenblack” (manufactured by Lion), “Vulcan” (manufactured by Cabot), “Black Pearls” (manufactured by Cabot) and “Acetylene Black” (manufactured by Denka Company Limited) (all are trade names); fullerenes such as C60 and C70; carbon fibers such as carbon nanotube, multi-walled carbon nanotube, double-walled carbon nanotube, single-walled carbon nanotube and carbon nanohorn; and graphene and graphene oxide, and preferable are carbon blacks.

The carbon may be used in combination with a conductive polymer such as polypyrrole and polyaniline.

The binder is one for mutually adhering the cathode catalyst, the conductive material and the like, and for example, those not dissolved in an electrolytic solution to be used as the electrolytic solution are mentioned, and fluorine resins such as polytetrafluoroethylene (PTFE), tetrafluoroethylene•perfluoroalkyl vinyl ether copolymer, tetrafluoroethylene•hexafluoropropylene copolymer, tetrafluoroethylene•ethylene copolymer, polyvinylidene fluoride, polychlorotrifluoroethylene and chlorotrifluoroethylene•ethylene copolymer are preferable.

The content of the cathode catalyst, the conductive material and the binder contained in the cathode catalyst layer is not particularly restricted. The compounding content of the conductive material is preferably 0.5 to 30 parts by mass, more preferably 1 to 20 parts by mass, particularly preferably 1 to 15 parts by mass per part by mass of the cathode catalyst, because the catalytic activity of the cathode catalyst can be improved more. The compounding content of the binder is preferably 0.1 to 10 parts by mass, more preferably 0.5 to 5 parts by mass, particularly preferably 0.5 to 3 parts by mass per part by mass of the cathode catalyst.

In a preferable embodiment of the present invention, the cathode catalyst layer for air secondary batteries comprises 1 to 20 parts by mass of the conductive material and 0.5 to 5 parts by mass of the binder per part by mass of the cathode catalyst for air secondary batteries.

In the cathode catalyst layer, the cathode catalysts, the conductive materials and the binders may each be used singly or two or more of them may be used in combination.

When a solvent is used in preparation of a cathode catalyst layer, it is preferable to use a solvent having a boiling point of 200° C. or less and it is more preferable to use water, methanol, ethanol, isopropanol, N,N-dimethylformamide, N-methylpyrrolidone (NMP), and mixed solvents thereof, as the solvent.

### (Air Secondary Battery)

The air secondary battery of the present invention has the cathode catalyst for air secondary batteries or the cathode catalyst layer for air secondary batteries.

The air secondary battery of the present invention preferably has a cathode catalyst layer containing the cathode catalyst for air secondary batteries, a cathode current collector adjacent to the cathode catalyst layer, a cathode terminal connected to the cathode current collector, a negative electrode active material layer containing a negative electrode active material, a negative electrode current collector adjacent to the negative electrode active material layer, a negative electrode terminal connected to the negative electrode current collector, and an electrolytic solution disposed between the cathode catalyst layer and the negative electrode active material layer.

In an air secondary battery according to one embodiment of the present invention, the cathode catalyst for air secondary batteries is contained in the cathode catalyst layer, and a negative electrode containing at least one negative electrode active substance selected from the group consisting of a zinc single body and zinc compounds, and an electrolytic solution are provided.

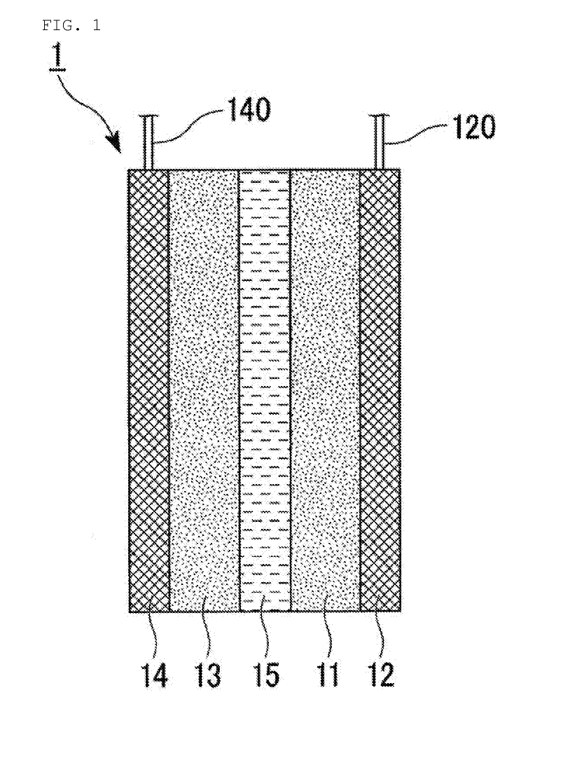

FIG. 1 is a diagrammatic schematic view showing one example of the air secondary battery of the present embodiment.

The air secondary battery 1 shown here has a cathode catalyst layer 11 containing the cathode catalyst, a cathode current collector 12, a negative electrode active material layer 13 containing the negative electrode active material, a negative electrode current collector 14, an electrolytic solution 15 and a vessel for accommodating them (not shown).

The cathode current collector 12 is disposed in contact with the cathode catalyst layer 11, constituting a cathode. The negative electrode current collector 14 is disposed in contact with the negative electrode active material layer 13, constituting a negative electrode. To the cathode current collector 12, a cathode terminal (lead line) 120 is connected, and to the negative electrode current collector 14, a negative electrode terminal (lead line) 140 is connected.

The cathode catalyst layer 11 and the negative electrode active material layer 13 are disposed so as to face and between them, an electrolytic solution 15 is disposed so as to contact them.

The negative electrode current collector 14 may be the same material as the cathode current collector 12.

The details of the electrolytic solution 15 will be described later.

The air secondary battery according to the present embodiment is not limited to one shown here, and if necessary, its constitution may be partially altered.

### (Cathode Current Collector)

Since the cathode current collector has a role of feeding electric current to a cathode catalyst, it is advantageous that the current collector is made of an electrically conductive material. As the preferable cathode current collector, a metal plate, a metal foil, a metal mesh, a metal sintered body, carbon paper and a carbon cloth are exemplified.

As the metal in the metal mesh and metal sintered body, exemplified are single bodies of metals such as nickel, copper, chromium, iron and titanium; and alloys containing two or more of these metals, and preferable are nickel, copper and stainless (iron-nickel-chromium alloy).

### (Electrolytic Solution)

The electrolytic solution comprises an electrolyte and a solvent.

The solvent is preferably water because an ion is dissociated easily.

Exemplified as the electrolyte are potassium hydroxide, sodium hydroxide, ammonium chloride, potassium carbonate, potassium hydrogen carbonate, sodium carbonate, sodium hydrogen carbonate, sodium formate, potassium formate, sodium acetate, potassium acetate, tripotassium phosphate, dipotassium hydrogen phosphate, potassium dihydrogen phosphate, trisodium phosphate, disodium hydrogen phosphate, sodium dihydrogen phosphate, sodium borate, potassium sulfate, sodium sulfate, ammonium hydrogen carbonate, ammonium formate, ammonium acetate, ammonium phosphate, ammonium dihydrogen phosphate, ammonium sulfate and ammonium hydrogen sulfate. Preferable are potassium hydroxide, sodium hydroxide, ammonium chloride, potassium carbonate, potassium hydrogen carbonate, sodium carbonate, sodium hydrogen carbonate, sodium formate, potassium formate, sodium acetate, potassium acetate, tripotassium phosphate, dipotassium hydrogen phosphate, trisodium phosphate and disodium hydrogen phosphate, more preferable are potassium hydroxide, sodium hydroxide and ammonium chloride. The electrolyte may be an anhydrate or a hydrate.

The electrolytes may each be used singly or two or more of them may be used in combination.

The concentration of the electrolyte in the electrolytic solution is preferably 1 to 99% by mass, more preferably 5 to 60% by mass, further preferably 5 to 40% by mass, though the concentration can be set optionally depending on use environments of the air secondary battery.

For the purpose of suppression of generation of a dendritic deposit containing a metal (for example, zinc) in the negative electrode, citric acid, succinic acid, tartaric acid and the like may be added as an additive to the electrolytic solution.

For the purpose of suppression of dissolution of an ion (for example, a zinc ion) derived from a metal in the negative electrode into the electrolytic solution in performing discharging, zinc oxide, zinc hydroxide, zinc sulfate, zinc formate, zinc acetate and the like may be added to the electrolytic solution.

A gelled electrolyte produced by allowing an electrolytic solution to be absorbed into a water absorbing polymer such as polyacrylic acid may also be used.

The cathode catalyst may be evaluated by any know methods and, for example, can be evaluated by measuring oxygen reduction activity and oxidative activity of water using a rotating ring disk electrode apparatus.

### (Negative Electrode)

In the negative electrode, at least one material selected from the group consisting of metal single bodies and metal compounds can be used as the negative electrode active material. The metal single body and metal compound include, for example, a zinc single body and a zinc compound, an aluminum single body and an aluminum compound, a lithium single body and a lithium compound and a magnesium single body and a magnesium compound, preferably a zinc single body and a zinc compound.

The zinc compound includes, for example, zinc oxide, zinc hydroxide and zinc alloy.

The zinc alloy includes, for example, an alloy of zinc and bismuth, an alloy of zinc and indium and an alloy of zinc, bismuth and indium.

The alloy of zinc and bismuth is preferably an alloy of zinc and bismuth in a content of 1 ppm to 3000 ppm by mass, more preferably an alloy of zinc and bismuth in a content of 100 ppm to 1000 ppm by mass.

The alloy of zinc and indium is preferably an alloy of zinc and indium in a content of 1 ppm to 3000 ppm by mass, preferably an alloy of zinc and indium in a content of 100 to 1000 ppm by mass.

The alloy of zinc, bismuth and indium is preferably an alloy of zinc, indium in a content of 1 ppm to 3000 ppm by mass and bismuth in a content of 1 ppm to 3000 ppm by mass, more preferably an alloy of zinc, indium in a content of 100 ppm to 1000 ppm by mass and bismuth in a content of 100 ppm to 1000 ppm by mass. By using these zinc alloys, the hydrogen overvoltage of zinc can be decreased and generation of a gas in a battery can be prevented more infallibly.

The above-described negative electrode may be used in the form of any of plate, particle and gel.

### (Other Constitutions)

The vessel accommodates the cathode catalyst layer 11, the cathode current collector 12, the negative electrode active material layer 13, the negative electrode current collector 14 and the electrolytic solution 15. Exemplified as the material of the vessel are resins such as polystyrene, polyethylene, polypropylene, polyvinyl chloride and ABS resin, and metals not reacting with the accommodation vessel for the cathode catalyst layer 11 and the like.

In the air secondary battery 1, an oxygen diffusion membrane may be separately provided. It is preferable that the oxygen diffusion membrane is provided outside of the cathode current collector 12 (on the opposite side to the cathode catalyst layer 11). Since the air secondary battery 1 has the oxygen diffusion membrane, oxygen or air is preferentially fed to the cathode catalyst layer 11 via the oxygen diffusion membrane.

The oxygen diffusion membrane may be a membrane though which oxygen or air can permeate successfully, and non-woven cloths or porous membranes made of resins are exemplified. Exemplified as the resin are polyolefins such as polyethylene and polypropylene; and fluorine resins such as polytetrafluoroethylene and polyvinylidene fluoride.

In the air secondary battery 1, a separator may be provided between the cathode and the negative electrode for preventing short circuit by contact of them.

The separator may be one made of an insulation material though which the electrolytic solution 15 can migrate, and non-woven cloths or porous membranes made of resins are exemplified. Exemplified as the resin are polyolefins such as polyethylene and polypropylene; and fluorine resins such as polytetrafluoroethylene and polyvinylidene fluoride. When the electrolytic solution 15 is used in the form of an aqueous solution, it is preferable to use a hydrophilizated material as the resin.

Though the form of the secondary battery of the present invention is not particularly restricted, examples thereof include coin, button, sheet, laminate, cylinder, plane and square.

The air secondary battery of the present embodiment is useful for, for example, large size electric power sources such as battery vehicle electric power sources and home electric power sources; compact electric power sources for mobile devices such as mobile phones and mobile personal computers.

### EXAMPLES

The present invention will be illustrated further in detail below by examples. Measurements in the examples were carried out using the following apparatuses.

### (1) Measurement of Powder X Ray Diffraction (XRD)

Apparatus: X'Pert PRO MPD manufactured by PANalytical
X ray tubular bulb: Cu-Kα
X ray output: 45 kV-40 mA

### (2) Measurement of ¹H-NMR

Apparatus: INOVA300 manufactured by Varian

### Synthesis Example 1

### Synthesis of Cobalt Oxyhydroxide

Into a flask were added 200 mg (0.80 mmol) of cobalt(II) acetate tetrahydrate and 30 ml of water, to prepare an aqueous solution. Then, 10 ml of a 1 M sodium hydroxide aqueous solution was added, and the mixture was stirred for 10 minutes. As a result, a brown product was obtained in the form of a precipitate, and the precipitate was collected by filtration, then, washed with water, to obtain 710 mg of cobalt oxyhydroxide. This cobalt oxyhydroxide was subjected to X ray diffraction (XRD).

2θ (°): 19.0, 32.5, 38.0

### Synthesis Example 2

### Synthesis of Metal Complex MC1

A compound 3 was synthesized via a compound 1 and a compound 2 as shown in the following reaction formula, then, a metal complex MC1 was synthesized using the compound 3 and a metal imparting agent.

### Synthesis of Compound 1

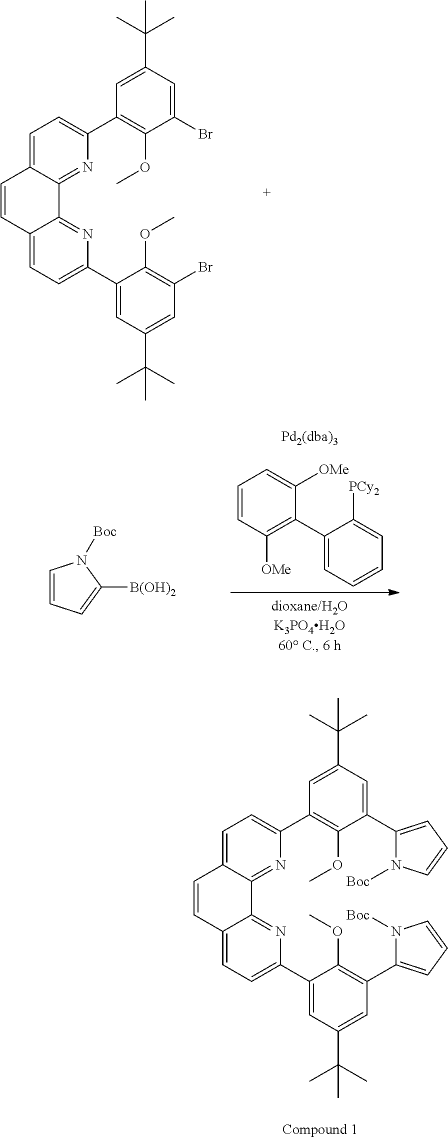

(wherein, Boc represents a tert-butoxycarbonyl group and dba represents dibenzylideneacetone.)

An argon gas atmosphere was prepared in a reaction vessel, then, 3.94 g (6.00 mmol) of 2,9-(3′-bromo-5′-tert-butyl-2′-methoxyphenyl)-1,10-phenanthroline (synthesized according to the description in Tetrahedron., 1999, 55, 8377.), 3.17 g (15.0 mmol) of 1-N-Boc-pyrrole-2-boronic acid, 0.14 g (0.15 mmol) of tris(benzylideneacetone)dipalladium, 0.25 g (0.60 mmol) of 2-dicyclohexylphosphino-2′,6′-dimethoxybiphenyl and 5.53 g (26.0 mmol) of potassium phosphate monohydrate were added to and dissolved in a mixed solvent of 200 mL of dioxane and 20 mL of water, and stirred at 60° C. for 6 hours. After completion of the reaction, the reaction solution was left to cool and distilled water and chloroform were added, and an organic layer was extracted. The resultant organic layer was concentrated, to obtain a black residue. This was purified in a silica gel column using chloroform as a developing solvent, to obtain a compound 1. The identification data of the compound 1 are shown below.

¹H-NMR (300 MHz, CDCl₃): δ (ppm)=1.34 (s, 18H), 1.37 (s, 18H), 3.30 (s, 6H), 6.21 (m, 2H), 6.27 (m, 2H), 7.37 (m, 2H), 7.41 (s, 2H), 7.82 (s, 2H), 8.00 (s, 2H), 8.19 (d, J=8.6 Hz, 2H), 8.27 (d, J=8.6 Hz, 2H).

### Synthesis of Compound 2

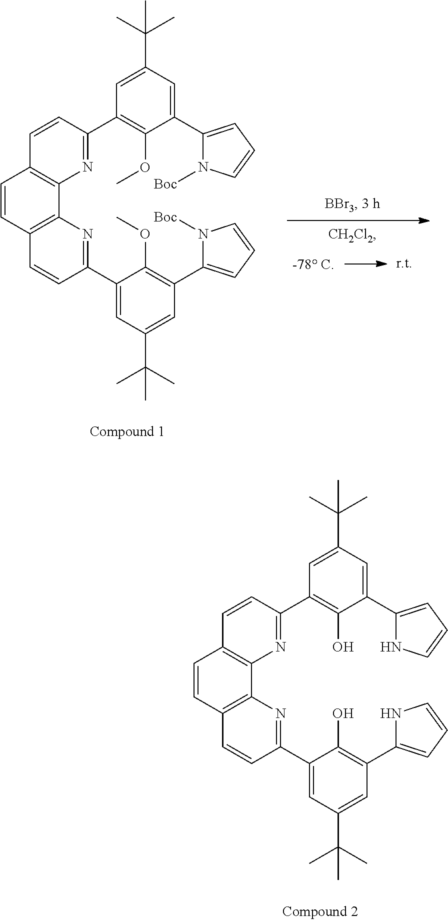 [SMILES: COc1c(-c2ccc3ccc4ccc(-c5cc(C(C)(C)C)cc(-c6cccn6C(=O)OC(C)(C)C)c5OC)nc4c3n2)cc(C(C)(C)C)cc1-c1cccn1C(=O)OC(C)(C)C ; CC(C)(C)c1cc(-c2ccc3ccc4ccc(-c5cc(C(C)(C)C)cc(-c6ccc[nH]6)c5O)nc4c3n2)c(O)c(-c2ccc[nH]2)c1]

(wherein, Boc represents a tert-butoxycarbonyl group.)

A nitrogen gas atmosphere was prepared in a reaction vessel, then, 0.904 g (1.08 mmol) of the compound 1 was dissolved in 10 mL of anhydrous dichloromethane. While cooling the resultant dichloromethane solution at −78° C., 8.8 mL (8.8 mmol) of a 1.0 M dichloromethane solution of boron tribromide was slowly dropped into this. After dropping, the mixture was stirred for 10 minutes under the same condition, and allowed to stand until reaching room temperature while further stirring. Three hours after, the reaction solution was cooled down to 0° C., and a saturated sodium hydrogen carbonate aqueous solution was added, then, chloroform was added and extraction thereof was performed, and an organic layer was concentrated. The resultant brown residue was purified in a silica gel column using chloroform as a developing solvent, to obtain a compound 2. The identification data of the compound 2 are shown below.

¹H-NMR (300 MHz, CDCl₃): δ (ppm)=1.40 (s, 18H), 6.25 (m, 2H), 6.44 (m, 2H), 6.74 (m, 2H), 7.84 (s, 2H), 7.89 (s, 2H), 7.92 (s, 2H), 8.35 (d, J=8.4 Hz, 2H), 8.46 (d, J=8.4 Hz, 2H), 10.61 (s, 2H), 15.88 (s, 2H).

### Synthesis of Ligand Compound 3

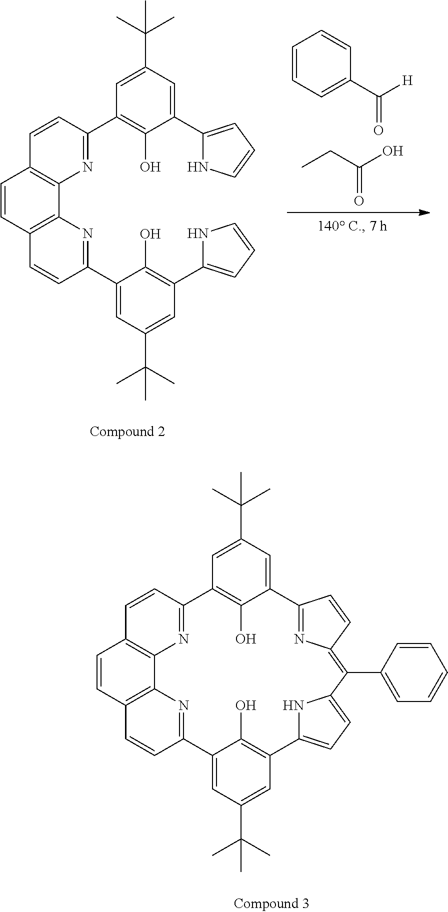

In a reaction vessel, 0.061 g (0.10 mmol) of the compound 2 and 0.012 g (0.11 mmol) of benzyaldehyde were dissolved in 5 mL of propionic acid, and the mixture was heated at 140° C. for 7 hours. Thereafter, propionic acid was distilled off from the resultant reaction solution, and the resultant black residue was purified in a silica gal column using a solvent prepared by mixing chloroform and methanol at a volume ratio of 10:1 as a developing solvent, to obtain a compound 3. The identification data of the compound 3 are shown below.

¹H-NMR (300 MHz, CDCl₃): δ (ppm)=1.49 (s, 18H), 6.69 (d, J=4.8 Hz, 2H), 7.01 (d, J=4.8 Hz, 2H), 7.57 (m, 5H), 7.90 (s, 4H), 8.02 (s, 2H), 8.31 (d, J=8.1 Hz, 2H), 8.47 (d, J=8.1 Hz, 2H).

### Synthesis of Metal Complex MC1

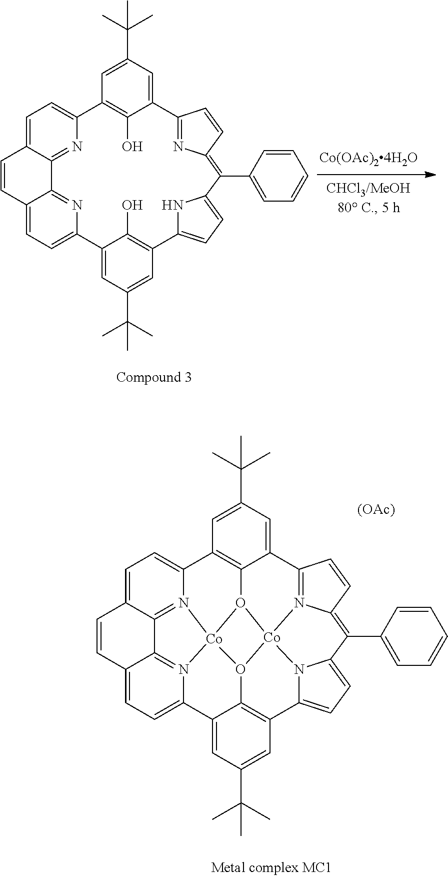

(wherein, Ac represents an acetyl group and Me represents a methyl group.)

A nitrogen gas atmosphere was prepared in a reaction vessel, then, 0.045 g (0.065 mmol) of the compound 3 and a mixed solution of 3 mL of methanol and 3 mL of chloroform containing 0.040 g (0.16 mmol) of cobalt(II) acetate tetrahydrate were mixed, and stirred for 5 hours while heating at 80° C. The resultant solution was concentrated, dried and solidified, to obtain a blue solid. This was washed with water, to obtain a metal complex MC1. In the metal complex MC1 in the reaction formula, “(0Ac)” denotes that 1 equivalent of an acetate ion is present as a counter ion. The identification date of the metal complex MC1 are shown below.

ESI-MS[M•⁺]: m/z=866.0

### Evaluation of Cathode Catalyst

### Comparative Example 1

A metal oxide La_{0.6}Ca_{0.4}CoO₃₋ₓ was synthesized according to a method described in a document (Electrochimica Acta 2003, 48, 1567).

The metal oxide obtained above and carbon (trade name: Ketjenblack EC600JD, manufactured by Lion Corporation) were mixed at a mass ratio of 1:4, and stirred in methanol at room temperature for 15 minutes, then, dried at room temperature under a reduced pressure of 200 Pa for 12 hours, to fabricate a cathode catalyst 1. The oxygen reduction activity and the oxidative activity of water were evaluated using the cathode catalyst 1.

As the electrode, a disk electrode in which a disk part was made of glassy carbon (diameter: 6.0 mm) was used. Into a sample bottle containing 1 mg of the cathode catalyst 1, 1 mL of a 0.5% by mass Nafion (registered trademark) solution (a solution obtained by 10-fold diluting a 5% by mass Nafion (registered trademark) solution with ethanol) was added, then, the sample bottle was irradiated with super sound for 15 minutes. The resultant dispersion (7.2 μL) was dropped onto the disk part of the electrode and dried, then, dried for 3 hours on a dryer heated at 80° C., to obtain an electrode for measurement.

### <Evaluation of Oxygen Reduction Activity>

Using this electrode for measurement, the current value of the oxygen reduction reaction was measured using the following measuring apparatus and measuring conditions. Measurement of the current value was conducted both under condition of saturation of nitrogen (under nitrogen atmosphere) and under condition of saturation of oxygen (under oxygen atmosphere), and a value obtained by subtracting the current value obtained by measurement under a nitrogen atmosphere from the current value obtained by measurement under an oxygen atmosphere was adopted as the current value of the oxygen reduction reaction. The current density was obtained by dividing this current value by the surface area of the electrode for measurement. The results are shown in Table 1.

The current density was a value in the case of −0.8 V for a silver/silver chloride electrode.

### (Measuring Apparatus)

RRDE-1 rotating ring disk electrode apparatus manufactured by Nikko keisoku

ALS model 701C dual electrochemical analyzer

### (Measuring Condition)

Cell solution: 0.1 mol/L potassium hydroxide aqueous solution (oxygen saturation or nitrogen saturation)

Solution temperature: 25° C.

Reference electrode: silver/silver chloride electrode (saturated potassium chloride)

Counter electrode: platinum wire

Sweeping speed: 10 mV/sec

Electrode rotation speed: 1600 rpm

### (Evaluation of Oxidative Activity of Water)

For the cathode catalyst 1, an electrode for measurement was fabricated in the same manner as for evaluation of the oxygen reduction activity, and the current value of the oxidative reaction of water was measured using this electrode using the following measuring apparatus and measuring conditions. Measurement of the current value was conducted under condition of saturation of nitrogen, and this current value was divided by the surface area of the electrode for measurement, to obtain the current density. The results are shown in Table 2. The current density was a value in the case of 1 V for a silver/silver chloride electrode.

### (Measuring Apparatus)

RRDE-1 rotating ring disk electrode apparatus manufactured by Nikko keisoku

ALS model 701C dual electrochemical analyzer

### (Measuring Condition)

Cell solution: 1 mol/L sodium hydroxide aqueous solution (Nitrogen saturation)

Solution temperature: 25° C.

Reference electrode: silver/silver chloride electrode (saturated potassium chloride)

Counter electrode: platinum wire

Sweeping speed: 10 mV/sec

Electrode rotation speed: 900 rpm

### Example 1

A cathode catalyst 2 was fabricated in the same manner as in Comparative Example 1 excepting that an oxyhydroxide was used instead of the metal oxide and cobalt oxyhydroxide and carbon were mixed at a mass ratio of 1:4 in Comparative Example 1, and the current values of the oxygen reduction reaction and the oxidative reaction of water were measured by a rotation disk electrode. The current density of the oxygen reduction reaction is shown in Table 1 and the current density of the oxidative reaction of water is shown in Table 2.

### Example 2

A cathode catalyst 3 was fabricated in the same manner as in Comparative Example 1 excepting that an oxyhydroxide was used instead of the metal oxide and cobalt oxyhydroxide, the metal complex MC1 and carbon were mixed at a mass ratio of 1:1:4 in Comparative Example 1, and the current values of the oxygen reduction reaction and the oxidative reaction of water were measured by a rotation disk electrode, and the current density was calculated. The current density of the oxygen reduction reaction is shown in Table 1 and the current density of the oxidative reaction of water is shown in Table 2.

TABLE 1

| | | current density |
|---|---|---|
| Evaluation | cathode catalyst | (mA/cm²) |
| Comparative | 1 | 3.4 |
| Example 1 | | |
| Example 1 | 2 | 3.9 |
| Example 2 | 3 | 5.4 |

TABLE 2

| | | current density |
|---|---|---|
| Evaluation | cathode catalyst | (mA/cm²) |
| Comparative | 1 | 3 |
| Example 1 | | |
| Example 1 | 2 | 162 |
| Example 2 | 3 | 172 |

### Evaluation of Electrode

### Example 3

### Fabrication of Powder for Gas Diffusion Layer

Carbon black (acetylene black, manufactured by Denka Company Limited), octylphenoxypolyethoxyethanol (Triton X-100, manufactured by Kishida Chemical Co., Ltd.) and water were mixed at a ratio of 1:1:30 (mass ratio), and a polytetrafluoroethylene (PTFE) dispersion (manufactured by Daikin Industries, Ltd., D-210C) was added to the mixture so that the proportion was 67% by mass with respect to carbon black, and the mixture was ground by a millser for 5 minutes, then, filtrated under suction and dried at 120° C. for 12 hours. After drying, this was ground by a millser and heated at 280° C. for 3 hours in air. Here, the resultant powder was ground again by a millser, to obtain a powder for gas diffusion layer.

### (Fabrication of Powder for Cathode Catalyst Layer)

Into a beaker were charged 100 ml of water and 1 ml of 1-butanol, and 0.18 g of carbon (Ketjenblack 300EC, manufactured by Lion), 0.16 g of cobalt oxyhydroxide prepared in Synthesis Example 1 and 0.08 g of the metal complex MC1 prepared in Synthesis Example 2 were added into this. After stirring for 2 hours, 0.16 g of a polytetrafluoroethylene (PTFE) dispersion (manufactured by Daikin Industries, Ltd., D-210C) was added bit by bit, and the mixture was stirred further for 1 hour. This was filtrated under suction and dried at 120° C. and ground by a millser, to obtain a powder for cathode catalyst layer.

### (Fabrication of Cathode Catalyst Layer)

An aluminum foil was placed on a hot press mold, and a nickel mesh (manufactured by The Nicolai Corporation) was placed on this, and 60 mg of a powder for gas diffusion layer was filled, and 60 mg of a powder for cathode catalyst layer was filled on the powder for gas diffusion layer. First, cold pressing was performed at a pressure of 80 kgf/cm², then, pressing was conducted for 10 seconds using a hot press kept at 350° C., to obtain a cathode catalyst layer. The reaction area of the cathode catalyst layer was 1.767 cm².

### (Evaluation of Electrode Property)

The cathode catalyst layer fabricated was mounted on a cell made of Teflon (registered trademark), and the electrode properties were evaluated in a 8 M potassium hydroxide aqueous solution using the following measuring apparatus and measuring conditions. The oxygen reduction potential and the oxidation potential of water at a current density of 50 mA/cm², and the difference in potential (V) thereof are shown in Table 3.

### (Measuring Apparatus)

Multi Potentiostat MODEL PS-04 manufactured by Tohogiken Co., Ltd.

### (Measuring Condition)

Electrolyte solution: 8 mol/L potassium hydroxide aqueous solution

Solution temperature: room temperature (23° C.)

Reference electrode: silver/silver chloride electrode (saturated potassium chloride)

Counter electrode: platinum electrode (Winkler electrode)

Sweeping speed: ±25 mV/180 sec

### Comparative Example 2

A powder for cathode catalyst layer was prepared and a cathode catalyst layer was fabricated in the same manner as in Example 3 excepting that 0.16 g of the metal oxide synthesized in Comparative Example 1 was used instead of 0.16 g of cobalt oxyhydroxide in Example, 3, and the electrode properties were evaluated. The oxygen reduction potential and the oxidation potential of water at a current density of 50 mA/cm², and the difference in potential (V) thereof are shown in Table 3.

TABLE 3

| | | oxidation | |
|---|---|---|---|
| | oxygen reduction | potential of | difference |
| | potential | water | in |
| | (current density | (current | potential |
| Evaluation | 50 mA/cm²) | density 50 mA/cm²) | (V) |
| Example 3 | −0.163 | 0.482 | 0.645 |
| Comparative | −0.348 | 0.590 | 0.938 |
| Example 2 | | | |

It was confirmed that the cathode catalyst containing cobalt oxyhydroxide was excellent in the oxidative activity of water.

Further, it was confirmed that the cathode catalyst layer using cobalt oxyhydroxide and the metal complex MC1 as the cathode catalyst was excellent in both the oxygen reduction activity and the oxidative activity of water.

When the oxidative activity of water is high, the charging reaction is successful, and when the oxygen reduction activity is high, the discharging reaction is successful. It was confirmed that the cathode catalyst layer of the present invention has excellent charging activity and discharging activity as a cathode catalyst layer of an air secondary battery since the cathode catalyst layer shows small difference in potential between the oxygen reduction potential and the oxidation potential of water.

### INDUSTRIAL APPLICABILITY

The cathode catalyst for air secondary batteries of the present invention can be used in the field of energy. The present invention can provide a cathode catalyst for air secondary batteries, a cathode catalyst layer for air secondary batteries and an air secondary battery, having excellent charging activity.

### EXPLANATION OF REFERENCES

1: air secondary battery
11: cathode catalyst layer
12: cathode current collector
120: cathode terminal
13: negative electrode active material layer
14: negative electrode current collector
140: negative electrode terminal
15: electrolytic solution

1. A cathode catalyst for air secondary batteries comprising an oxyhydroxide of a metal.

2. The cathode catalyst for air secondary batteries according to claim 1, wherein the metal is at least one metal selected from the group consisting of iron, cobalt, manganese and nickel.

3. The cathode catalyst for air secondary batteries according to claim 1, wherein the oxyhydroxide of a metal is cobalt oxyhydroxide.

4. The cathode catalyst for air secondary batteries according to claim 1, further comprising a metal complex.

5. The cathode catalyst for air secondary batteries according to claim 4, wherein a metal atom or a metal ion contained in the metal complex is manganese, manganese ion, iron, iron ion, cobalt, cobalt ion, copper, copper ion, zinc or zinc ion.

6. The cathode catalyst for air secondary batteries according to claim 4, wherein the metal complex is a polynuclear metal complex.

7. The cathode catalyst for air secondary batteries according to claim 4, wherein a ligand contained in the metal complex is an aromatic compound.

8. The cathode catalyst for air secondary batteries according to claim 4, wherein the content of the metal complex is 0.1 to 1 part by mass per part by mass of the oxyhydroxide of a metal.

9. A cathode catalyst layer for air secondary batteries comprising the cathode catalyst for air secondary batteries according to claim 1.

10. The cathode catalyst layer for air secondary batteries according to claim 9, comprising 1 to 20 parts by mass of a conductive material and 0.5 to 5 parts by mass of a binder per part by mass of the cathode catalyst for air secondary batteries.

11. An air secondary battery comprising the cathode catalyst for air secondary batteries according to claim 1.

12. An air secondary battery comprising the cathode catalyst layer for air secondary batteries according to claim 9.
